(19) United States
(12) Patent Application Publication
(10) Pub. No.: US 2009/0167511 A1
(43) Pub. Date: Jul. 2, 2009

(54) Surveillance system for real-time threat monitoring

(75) Inventors: Pierre Strombeck, Lidingo (SE); Peter Strombeck, Lidingo (SE); Daniel Svensson, Johanneshov (SE); Jan Nilsson, Hollviken (SE)

Correspondence Address: POTOMAC PATENT GROUP PLLC, P. O. BOX 270, FREDERICKSBURG, VA, 22404, US

(73) Assignee: Portendo AB, Kista (SE)

(21) Appl. No.: 11/630,469

(22) PCT Filed: Jun. 14, 2005
(86) PCT No.: PCT/SE05/00898

§ 371 Date: Nov. 29, 2007

(30) Foreign Application Priority Data
Jun. 22, 2004 (SE) 0401607-7
Mar. 21, 2005 (SE) 0500634-1

(51) Int. Cl. B60Q 1/00; G08B 21/00; G08B 23/00; G08B 1/08

(52) U.S. Cl. 340/425.5; 340/540; 340/539.1; 340/533

(57) ABSTRACT

Surveillance system for automatic detection and presentation of threat indications, the system comprising several threat indication detectors and at least one central unit adapted for communication with said threat indication detectors and for presentation of threat images. Threat information signals are transferred automatically from the threat indication detectors to the central unit, and each threat indication detector can be located both immobile, semi-mobile of mobile.

### TECHNICAL FIELD

This invention relates to a system for automatic and continuous detection and presentation of threats in real-time, and a threat indication detector adapted to be included in such a system.

### BACKGROUND OF THE INVENTION AND PRIOR ART

Daily, the world around us is threatened by terrorist organizations attempting e.g. to influence the political direction of the world, by means of various bombing attacks against buildings and people. For this reason, most states are provided with authorities for monitoring and fighting security threats, e.g. the customs, intelligence service and the police. Their surveillance methods mainly consist of intelligence activities, in combination with isolated efforts of special forces trained to detect bombs, gas attacks and similar threats to the security. Normally, the bomb searching will be performed by specially trained dogs, while the custom officers and security personnel at airports and in harbours also use scanners for the scanning of luggage and passengers.

Normally, the security surveillance regarding threats is based on intelligence activities, e.g. by the public tipping and informing the police and the customs. This information is analysed, and if it is relevant, a supplementary inspection and investigation may be performed on site by police officers and customs officers. Security surveillance may also, in some situations, be performed by precautionary scanning of an area. Normally, dogs or some type of equipment, based e.g. on gas chromatography of spectrography, will be used when detection is performed at an inspection. All of these methods are very costly and require well-trained inspection teams for handling the dogs and for using the inspection equipment.

Previously known detection systems within this field have several disadvantages, e.g. they involve high costs, require handling and active participation of trained personnel, are not adapted for continuous surveillance, lack real-time reporting to a common surveillance central for a compiled presentation of threats, and have a low area coverage.

An object of this invention is to provide a surveillance system for a cost efficient and continuous detection and presentation of threat indications in real-time, in order to allow an efficient action by personnel, if needed.

### DESCRIPTION OF THE INVENTION

The surveillance system according to this invention achieves this and other objects by comprising a network of threat indication detectors, which are distributed with a high coverage and automatically transmit information regarding detected threat indications to one or more common central units. In order to achieve a high coverage, each of the threat indication detectors of the system is adapted both for a mobile location and immobile (stationary) location, or a semi-mobile location, allowing a great flexibility and makes the prediction of the scan more difficult. A threat indication detector can be mounted permanently or detachably in e.g. a building or in a transporting device, and may also be portable, to be carried by personnel, e.g. in the pocket of a uniform. The low cost of a threat indication detector, and the flexible use, allows a high coverage and a good geographic distribution, which, furthermore, is unpredictable. By using existing communication systems, the detected threat indications can be transferred automatically to a central unit, in which e.g. police officers monitor a threat indication picture, which is compiled automatically and continuously and presented e.g. as a map.

The surveillance system according to this invention intends to detect threat indications, which originates e.g. from explosives, hazardous gases, radioactive material or organisms, and the surveillance system displays a compilation of the threat indications with complete coverage. Thus, the surveillance system according to this invention allows autonomous, continuous and area-covering detection of threat indication; mapping and display of threat indications and their movements in real-time; efficient and non-predictable scanning of large areas and spaces; and a threat indication detection that can be performed to a large extent without any active participation of personnel.

These objects are achieved by the invention according to the appended claims, which relate to a system for detection and presentation of threat indications, and a threat indication detector intended to be included in this system. The system comprises several threat indication detectors and at least one central unit, which is arranged to communicate with said threat indication detectors, and to present threat indications. The threat indication detectors comprise sensing means for threat indication sensing, time indication means, positioning means, and communication means for automatic transfer of threat information signals to the central unit. The threat information signals indicate the type of threat, detector identity, detector position, and point of time, and the central unit comprises means for automatic compilation of received threat information signals and presentation means for display of continuously updated threat pictures, wherein each threat indication detector is adapted both for immobile and mobile locations. An immobile location is defined as a stationary location, not movable while in operation, while a mobile location is movable while in operation.

The communication means may be arranged to establish a wireless connection with said central unit, as well as to establish a wire connection from an immobile location of the threat indication detector, wherein the connection may be adapted for two-way communication.

The system may also comprise one or more threat indication detectors exclusively adapted for immobile locations, provided with communication means configured to establish a wire connection with the central unit.

The system may comprise at least one threat indication detector arranged to be portable, and at least one threat indication detector arranged to be mounted on a vehicle.

Further, the presentation means on the central unit may be adapted to present threat pictures on a display as a map provided with superimposed and continuously updated threat indication markers, and the central unit may comprise a database for storage of the threat information.

### BRIEF DESCRIPTION OF THE DRAWINGS

The invention will be described in more detail below, with reference to the FIGS. 1-3, of which:

FIG. 1 schematically illustrates a surveillance system according to the invention,

FIG. 2 schematically illustrates the components in a threat indication detector comprised in this invention, and

FIG. 3 schematically illustrates a central unit according the invention.

### DETAILED DESCRIPTION OF THE INVENTION

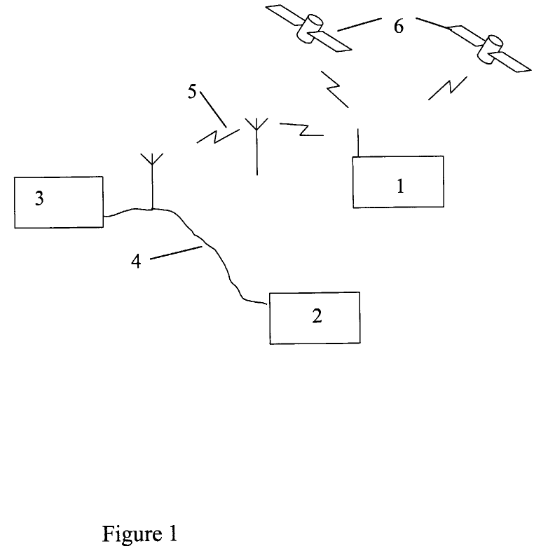

The system according to the invention is illustrated in FIG. 1 showing two threat indication detectors 1, 2, which are communicating with a central unit 3. One of the threat indication detectors 1 is provided with positioning equipment 6, and a wireless radio-frequency connection 5 with the central unit, and is in this manner adapted for an immobile as well as for a mobile location. The expression “mobile location” indicates that the threat indication detector is placed on a location that is movable while in operation, which means that it may be mounted e.g. in a vehicle, or portable and carried by a person. The expression “immobile location” indicates that the threat indication detector is located to be stationary while in operation, which means that it may be mounted e.g. in a building. The second threat indication detector 2 in FIG. 1 is arranged exclusively for an immobile location, which means that it has a wire connection 4 with the central unit 3, and no active positioning equipment is needed. The expression “semi-mobile” indicates a movable location, involving a pre-determined movement, such as in a train or an airplane. The threat indication detectors 1, 2 included in a system according to this invention are adapted to perform continuous detection of threat indications. The threat information relating to the detected threat indication is transferred automatically, either wirelessly via e.g. a radio connection 5 or by wire 4, to a central unit 3, and the threat information comprises type of threat, point of time, position, and detector identity. The threat information relating to each threat indication detection is, thereafter, compiled in the central unit into a continuous geographical threat information picture.

A first embodiment of a system according to this invention is a surveillance system comprising one or more central units 3, to each of which an arbitrary number of threat indication detectors 1 are connected, each designed both for an immobile and a mobile location by being provided with positioning means 6 and a wireless connection 5 with a central unit 3. However, a threat indication detector 1 may also be provided with a wire connection 4 for a permanent connection to a central unit, to be used in an immobile location. A second embodiment of this system further comprises threat indication detectors intended only for an immobile location.

Each central unit 3 receives threat information transferred automatically from the threat indication detectors 1, 2 within the system, and compiles the information automatically into one common threat indication picture, which is suitably presented, e.g. on a display screen, as a map provided with superimposed threat indication markers, which may be updated continuously. Thereby, the staff that is present at the central unit gets an opportunity to monitor the displayed threat indication picture, and can easily discover a detected threat indication, determine the type of threat and its position, and in this way quickly determine the extent of a threat and take the necessary steps, such as e.g. to alert personnel to perform an inspection or an action on the location of the threat indication.

A threat indication detector 1, 2 according to this invention has a different design depending on whether it should be capable of both mobile and immobile location, or only immobile location. It can also be designed differently regarding the mounting means, to be mountable permanently of detachably, e.g. in a building or in a vehicle, and/or to be portable.

The threat indication detector comprises a sensing part for monitoring of the surrounding environment, and the sensor is adapted to convert indications regarding e.g. explosives, gases, organisms and radiation to an electric signal. This threat type indication signal is, thereafter, combined with positioning information from the positioning means comprised in the detector, and with time information and detector identity, into a threat information signal, which, thus, indicates the type of threat, the position, the detector identity and point of time, and this threat information signal is automatically transferred to the central unit, by means of the internal communication means of the detector.

Since a threat indication detector according to this invention is designed either to be located both mobile and immobile, or only immobile, to be permanently or detachably mounted, or to be portable, and to function autonomously, with an automatic transfer of detected threat indications to a central unit, a very efficient, flexible and non-predictable scanning of an area regarding threat indications is possible. A mobile location means to e.g. be carried by a person, an animal or in a vehicle, while an immobile location means to be mounted e.g. in a building. The transfer of the threat indication signals is preferably taking place in real-time, i.e. in connection with a detection. A detector can be designed with a sensing part that is consumed during use of the detector, and such a detector is preferably adapted to inform the central unit in case the detector needs maintenance. A threat indication detector according to this invention is designed for a continuous analysis of the environment with respect to the presence of one or more substances, radiation or organisms. When a detection has occurred, the information is transferred in a threat information signal sent from the detector to a central unit, relating to the type of threat, point of time, and the position, and also denoting the detector identity. The detector can also be designed to denote the concentration and/or quantity of a detected substance, to be included in the transferred threat indication signal.

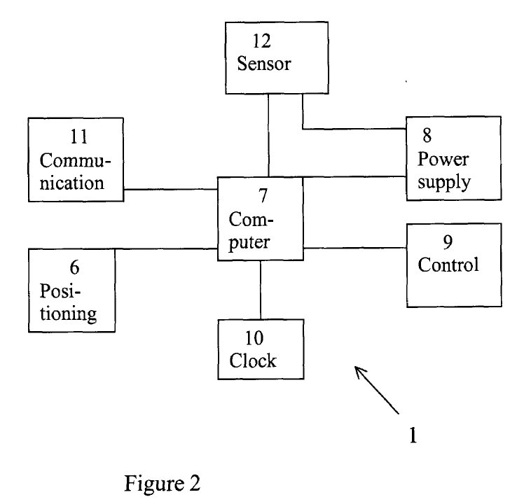

The parts of a threat indication detector 1, according to an embodiment designed for both immobile and mobile location, is illustrated in FIG. 2, comprising a computer 7, power supply 8 with a battery and a voltage converter, control means 9 for supply voltage and program execution, clock 10 for time stamps and time control, communication means 11, having a wireless interface with receiver, sender and an antenna, and possibly also a wire interface, positioning means 6 for localisation, comprising a receiver and antenna for satellite reception, and a sensor 12 for one or more substances, organisms or radiation. The parts comprised in the detector, as above, will now be described in more detail below, with reference to FIG. 2.

The sensor 12 included in the detector according to the invention senses the substance, radiation and/or organism, and by reading the sensor signals the detector is informed of the type and quantity. Some types or sensors have a limited durability, and in this case the detector may give notice when the sensor is consumed.

The power supply 8 in the detector may consist of a built-in battery. If suitable, a complementary external power supply may be provided, e.g. solar cells, a mains supply, or a power supply of a vehicle.

A threat indicator detector 1 adapted for mobile placement performs locating by means of a built-in positioning equipment 6 for geographical locating. A preferred embodiment of a detector adapted for mobile placement uses satellite positioning (e.g. GPS [Global Positioning System], Glonass, Galileo) combined with radio-based locating (e.g. GSM [Global System for Mobile communication], 3G)), but radio systems without locating function primarily uses satellite positioning.

A threat indication detector 2 according to a second embodiment, only adapted for immobile locations, may alternatively store data regarding the detector location in the central unit, wherein no active positioning equipment is required.

A threat indication detector 1 adapted for both mobile and immobile locations primarily communicates via a wireless connection, such as by radio communication, but it may, additionally, be provided with an interface for a wire connection to be used in an immobile location. Preferably, the communication is two-way, in order to provide an opportunity for remote control and remote maintenance of the detector.

A clock 10 in the detector performs time stamping and time control of events, and the clock is synchronized by means of a satellite positioning equipment or a communication link.

A function supervisor 9 in the detector supervises the operating status, reports error conditions, and resets the detector in case of en emergency error.

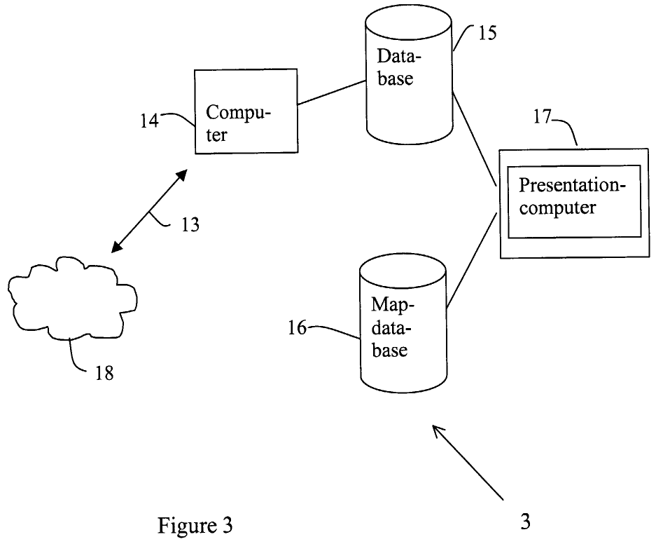

A central unit 3 according to an embodiment of the invention is illustrated in FIG. 3, and comprises means for a communication link 13 to a network connection 18, e.g. a telecommunication network, the Internet, or radio, a computer 14, a central unit database 15 for storage of threat indication information, a GIS (Geographic Information System)-database 16 for map information, and one or more computers 17 for the presentation.

The central unit 3 receives and stores information transferred from the threat indication detectors 1, 2 as threat information signals, and compiles and presents the threat information. The presentation can take place in several ways, such as maps with threats and threat variations, standard levels and deviations, the dynamics of variations, etc. A large number of detectors lead to a continuous, redundant surveillance and high geographical resolution. The central unit communicates with the detectors, and with other central units, as well, if necessary. The detectors transfer information to the central unit, which is able to return information to the detectors regarding control and maintenance. The central unit may also communicate with other centrals/systems, such as other security or surveillance centrals, or with the police or with guards. Processing is performed when threat information signals are received from the detectors, the processing comprising forwarding of the information to the police or to guards and using the information from the detectors to generate a time varying geographical presentation of the detected threat indication. Some of the integral part of a central unit, as above, will be described in more detail below, with reference to FIG. 3.

The communication performed by a central unit involves sending and receiving information to/from the detectors, other central units and liaison centrals. The communication is performed by means of a communication link 13, wirelessly or by a wire connection or via an existing network, e.g. the Internet or a telecommunication network. Presentation of the threats can e.g. be performed by showing a map on the display of a computer 17 for presentation, such as a city map, onto which the information regarding detected threats is superimposed. Various geographical properties or numerical attachments can be used for the type of threat, actuality, movement, level, variations, speed of the variations, etc. The presentation in the central unit can be event controlled by the occurring threats, or show a predetermined surveillance area. Other types of presentations may take place, if necessary, such as airplane- and satellite images, diagrams, tables, statistics, time variations, etc.

By threat indication detectors located in public buildings and places, in public communications and cargo transporting vehicles and carried by police officers and guards, threat information is obtained with high area coverage. Detection takes place e.g. when radiation or molecules from a substance or organism is sensed by a sensor of a detector, which may be caused by the substance being brought or transported in the vicinity of a detector, or by a mobile detector being brought or transported in the vicinity of the substance. When a threat indication detection occurs, the detector reports the type of detection and time and place to a central unit as a threat information signal sent from the detector to the central unit. The central unit stores the report with the threat information signals in the database 15, wherein the information can be selected and presented according to the requirements. By means of continuous reading and reporting in real-time, intelligence information regarding a type of threat and its origin is created, and regarding changes in and movements of a threat. This information can be presented in several different ways, geographically and statistically.

Since both immobile and mobile location of the detectors is possible, am area-covering (inside buildings also volume-covering) network with scanning points can be created. The immovably located detectors scan threats in the vicinity, which comprises threats passing through the vicinity. One example is immovably located detector mounted on water pipes to sense threats including contamination or additives in the drinking water. Immovably located detectors in buildings, in venting systems, entrances to sports centres, etc. are able to sense threats brought into or placed inside a building. The movably located detectors can e.g. accompany transporting vehicles, such as subway trains, ships, trailers, containers, buses, or cars. Portable detectors are carried or mounted detachably for daily use, and can be carried by uniformed personnel, such as police officers, custom officers, postmen, garbage collectors, etc. or by non-uniformed personnel, such as security officers, employees, volunteers at sports events, private persons, or even by animals. These detectors can also be used for temporary mounting on bicycles, boats, motor vehicles, and at various events and conferences that requires scanning.

The flexible system with threat indication detectors adapter for both immobile and mobile locations allows am area-covering scanning, being static as well as dynamic. Detectors adapted for mobile location can accompany vehicles, cargo and transporting routes and, thereby, accomplish scanning of locations with an organized transport of people and cargo. A movably located detector may be moved along a predetermined route, e.g. of a postman or a garbage collector, or along completely unpredictable routes, of e.g. a police officer, a security officer or any private person. Altogether, this provides a scanning area that is extremely difficult to predict of someone wishing to avoid a detection, and at the same time the scanning is able to cover most places, vehicles and the inside of building.

A great advantage with this invention is that the detectors are designed for autonomous use, but an active participation by personnel is also possible. However, normally it is used autonomously, i.e. the measuring and communication is performed by a detector without participation of anyone. This means that a carrier and those around him are unaware of an occurred detection and of a central unit having received information from the detector.

Certain types of detectors can require regular replacement of old filters, sensor parts or batteries. These detectors will send a notification to the central unit when a replacement has to be performed, to be forwarded to maintenance personnel. The operating status is checked and possible errors notified to the maintenance staff by means of a regular communication between the central unit and each detector.

The information transfer between the detectors and the central unit is performed automatically, and the information can be processed in one or more central units, depending on the circumstances. According to a possible embodiment of the system according to this invention, a local central unit handles all threats within a defined geographical area, and according to another possible embodiment of the system, a particular central unit handles a particular threat indication type.

By identifying each detector in association with the transfer of threat information to a central unit, threat indications can be evaluated and sorted out if they are generated erroneously. Detectors that may be in the wrong hands can be shut off from further operation by means of remote control from the central unit.

Monitoring of the presentation in the central units may be performed by manual reading of the presentation computers 17 or via automatic alerts from a database server, which may be portable, or by means of a suitable combination of these methods. A portable computer allows an interactive field use. The display on the presentation computer 17 can be based on presentation integrated with graphics (e.g. maps), pictures (e.g. air photos), as diagrams (e.g. statistics), as a text, as a movable graphic/picture or as a combination of any of these. Information from the presentation computer 17 can be forwarded, either completely of partly, to field personnel of to other central units.

The information stored in the database 15 regarding a threat indication can either be selected or complete. Examples of information to be stored are the type of threat, type of detector, and detector identity, position coordinates, movements and propagation pattern, and information regarding a threat indication position, such as a map, a picture, information regarding a location, a particular building, a road, a particular vehicle, or the names of certain people.

The above-described system allows an efficient, flexible, autonomous and non-predictable scanning of an area regarding threat indications.

The present invention is not limited to the embodiments described above, but may be modified within the scope of the appended claims.

1. A system for detection and presentation of threat indications, the system comprising several threat indication detectors and at least one central unit adapted to communicate with said threat indication detectors and for presentation of threat indications, wherein said threat indication detectors comprise sensing means for threat indication sensing, time indication means, positioning means, and communication means for automatic transfer of threat information signals to a central unit, said threat information signals indicating type of threat, detector identity, detector position and point of time, said central unit comprising means for automatic compilation of received threat information signals and presentation means for display of continuously updated threat pictures, wherein said threat indication detectors are adapted both for immobile and mobile locations.

2. A system according to claim 1, characterized in that the communication means is arranged to establish a wireless connection with said central unit.

3. A system according to claim 2, characterized in that said communication means is arranged to establish a wire connection with said central unit in the case of an immobile location of the threat indication detector.

4. A system according to claim 2, wherein said connection is adapted for two-way communication.

5. A system according to claim 1, further comprising one or more threat indication detectors adapted exclusively for immobile locations, provided with communication means configured to establish a wire connection with said central unit.

6. A system according to claim 1, further comprising at least one threat indication detector arranged to be portable.

7. A system according to claim 1, further comprising at least one threat indication detector arranged to be mounted on a vehicle.

8. A system according to claim 1, wherein the presentation means of the central unit is adapted to present threat pictures on a display as a map provided with superimposed and continuously updated threat indications markers.

9. A system according to claim 1, wherein the central unit comprises a database for storing threat information.

10. A threat indication detector adapted to be included in a system for detection and presentation of threat indications, according to claim 1.
